(19) United States
(12) Patent Application Publication
(10) Pub. No.: US 2006/0071098 A1
(43) Pub. Date: Apr. 6, 2006

(54) Hexagonal sprinkler nozzle

(75) Inventors: Chad McCormick, West Covina, CA (US); Bert Broerman, Riverside, CA (US)

Correspondence Address: INSKEEP INTELLECTUAL PROPERTY GROUP, INC, 2281 W. 190TH STREET, SUITE 200, TORRANCE, CA, 90504, US

(73) Assignee: The Toro Company

(21) Appl. No.: 10/957,963

(22) Filed: Oct. 4, 2004

(51) Int. Cl. B05B 1/26

(52) U.S. Cl. 239/504; 239/553.3; 239/553.5; 239/556; 239/562

(57) ABSTRACT

The present invention provides a sprinkler nozzle having patterned exit ports within the nozzle to maximize flow area while straightening the water stream.

### FIELD OF THE INVENTION

This invention relates to irrigation sprinkler nozzles, and more particularly to a sprinkler nozzle construction that enhances and maximizes water flow while maintaining uniform water direction.

### BACKGROUND OF THE INVENTION

Irrigation sprinklers are popular solutions for providing water via a single water stream rotated in a circle around a vertical rotational axis. This water stream is thrown by a sprinkler nozzle mounted within the sidewall of the sprinkler head. A circular watering pattern is created when the sprinkler is rotated by an internal drive mechanism and part-circle arc watering patterns are similarly created by sprinklers with reversing drive mechanisms.

Sprinklers using side mounted nozzles generate a great deal of water turbulence within the sprinkler body, due to the turns and convolutions of the water between the water input and water output of the sprinkler head. Uncorrected water turbulence within a sprinkler body may thus lead to a broken, distorted, or irregular water stream exiting the nozzle.

Traditionally, water “straighteners” and other turbulence reducing devices are used within the water path inside the sprinkler body to reduce this turbulence before the water is ultimately thrown from the nozzle. With these devices, water is more uniformly and more efficiently thrown from the sprinkler nozzle thus resulting in delivering the water the greatest possible distance and with the greatest precision.

Although water straighteners and turbulence reducing devices more or less function to provide a substantially cohesive water stream, such components require a significant degree of engineering and take up scarce space internal to the sprinkler body that is already at a premium. Moreover, such components also increase the overall cost and complexity of the sprinkler.

### OBJECTS AND SUMMARY OF THE INVENTION

Therefore, it is an object of the present invention to overcome the disadvantages associated with prior art turbulence reducing devices.

It is another object of the present invention is to provide a sprinkler nozzle that straightens the thrown water stream.

Another object of the present invention is to provide a sprinkler nozzle that reduces turbulence of the thrown water stream.

Yet another object of the present invention is to provide a sprinkler nozzle that eliminates the need for separate water straightening components.

Yet another object of the present invention is to provide a sprinkler nozzle that maximizes direction, speed and mass of the water stream radius.

The present invention overcomes these disadvantages of the prior art by providing an improved sprinkler nozzle having patterned exit ports within the nozzle to maximize flow area for improved stream performance.

### BRIEF DESCRIPTION OF THE DRAWINGS

FIG. 1 illustrates a side perspective view of the a sprinkler with a patterned nozzle according to the present invention;

FIG. 2 illustrates a back perspective view of the patterned nozzle of FIG. 1 according to the present invention;

FIG. 3 illustrates a front perspective view of the patterned nozzle of FIG. 1 according to the present invention;

FIG. 4 illustrates a side view of the patterned nozzle of FIG. 1 according to the present invention; and

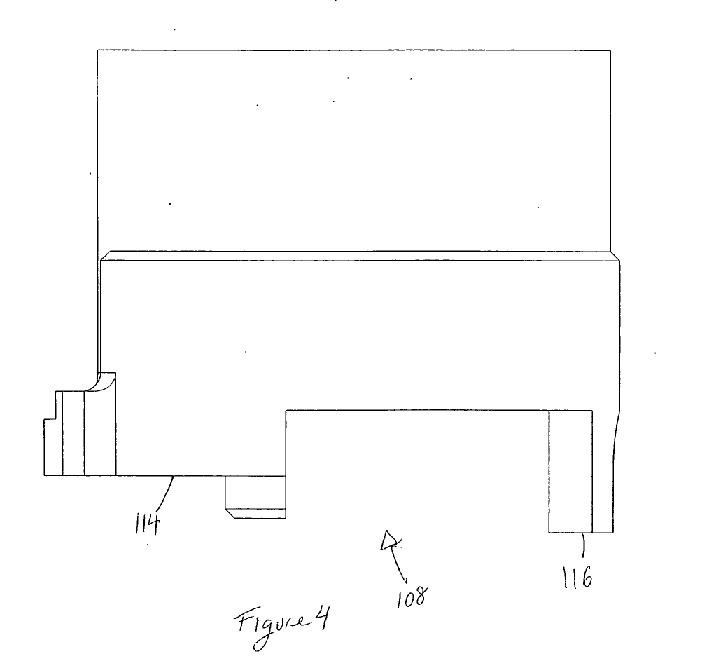

FIG. 5 illustrates a front view of the patterned nozzle of FIG. 1 according to the present invention.

### DETAILED DESCRIPTION OF THE INVENTION

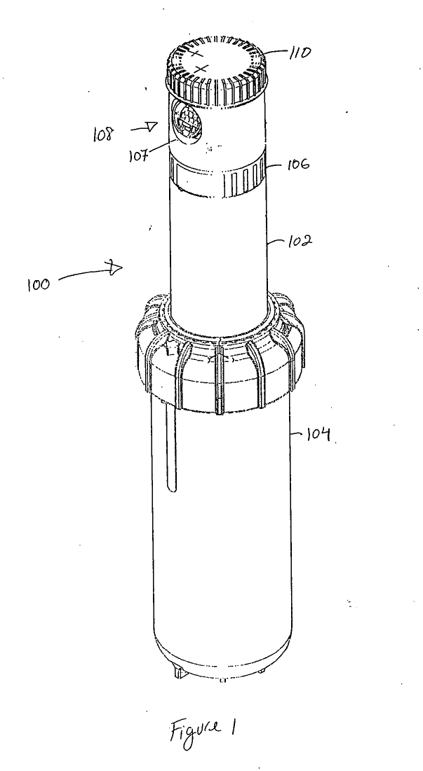

FIG. 1 illustrates a typical “pop-up” sprinkler having a sprinkler body 104 and a riser assembly 102. An arc adjuster 106 allows a user to adjust the area the sprinkler 100 waters while the riser cap 110 prevents dirt from entering riser 102. The riser 102 also contains a nozzle aperture 107, housing a patterned nozzle 108 in accordance with a preferred embodiment of the invention.

Generally, the bottom of sprinkler body 104 is connected to a water supply (not shown), allowing for the transfer of water to the sprinkler 100. As the water travels through the body of the sprinkler 100, it passes around a variety of obstacles, such as turbines, geared drive mechanisms, and arc adjustment assemblies. These obstacles provide a convoluted water path creating water turbulence within the sprinkler 100 and a broken or distorted water stream projecting outside the sprinkler 100. This turbulence may be supplemental to turbulence already present in the water, due to twist, turns, and other flow irregularities that may be present in the irrigation water piping that connects to the sprinkler.

In order to counteract this turbulence, the present invention provides a nozzle design that “straightens” the water stream, substantially removing the effects of upstream turbulence at the nozzle. As such, the sprinkler 100 does not need separate water straighteners internal to the body of the sprinkler 100 to obtain a straight, unbroken stream of water.

In this regard, it should be understood that although this embodiment is described with respect to a “pop-up” sprinkler, any sprinkler design can be used, so long as it has a nozzle aperture 107 sized and positioned to accommodate the nozzle 108.

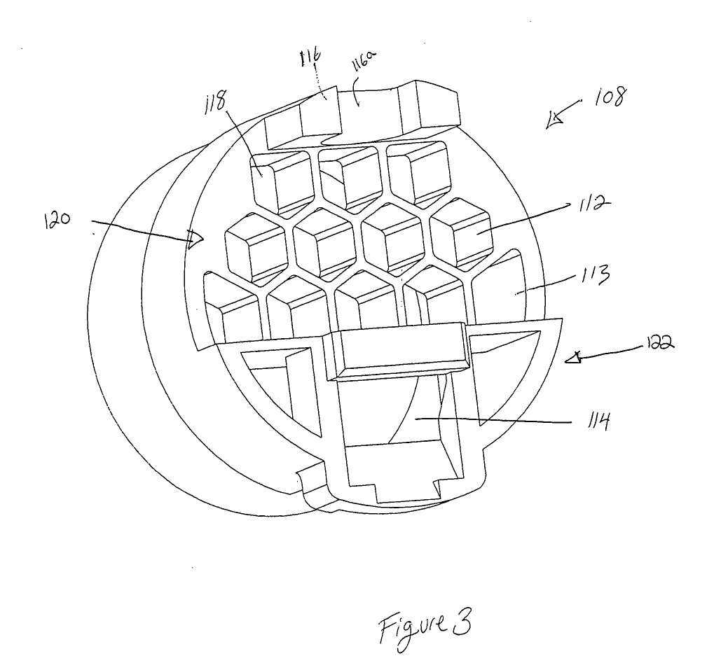

As with prior art nozzles, the preferred embodiment of the nozzle 108 in accordance with the present invention is secured within nozzle aperture 107 of the sprinkler 100 and provides an output for the irrigation water feeding into the sprinkler 100. As best seen in FIG. 3, the nozzle 108 has protrusions 116 located on the upper outside face of the nozzle 108. The protrusions 116 extend perpendicularly away from the nozzle 108 to form a half circle shape 116a between the two protrusions 116. When the nozzle 108 is inserted into the nozzle aperture 107, a screw (not shown) screws down through the half circle shape 116a, thereby securing the nozzle 108 within the nozzle aperture 107. In this manner, the nozzle 107 may be easily secured into place or removed from the sprinkler 100.

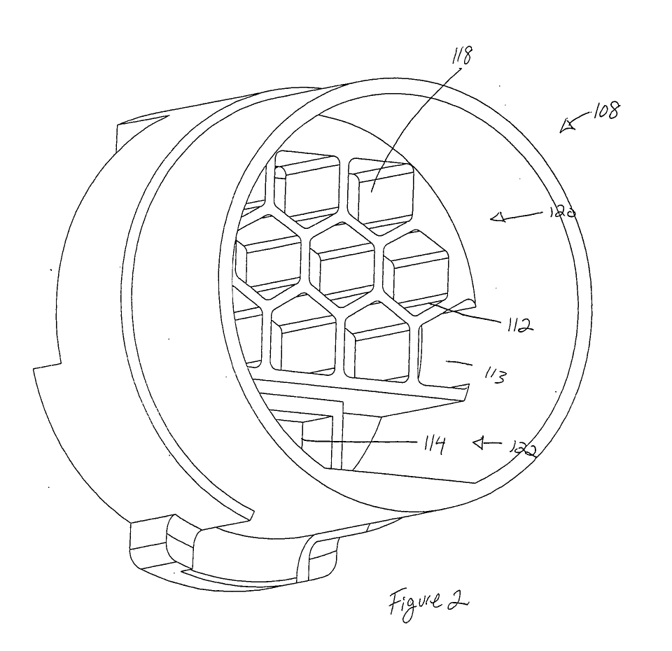

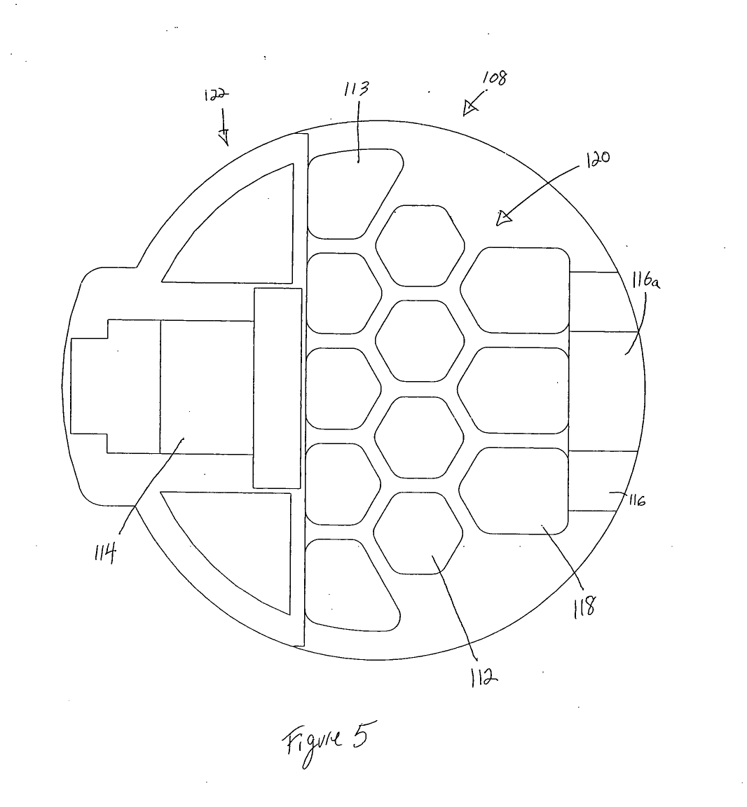

As seen in the FIGS. 2, 3 and 5, the patterned nozzle 108 is generally composed of an upper honeycomb shaped section 120 and a lower open section 122. The lower open section 122 of the nozzle 108 is composed of a rectangular breakup port 114, which disrupts a portion of a water stream as it exits the nozzle 108.

The breakup port 114 is analogous to an adjustable breakup screw on prior art sprinkler models which are typically located at the bottom of a nozzle aperture and can be adjusted upward into the path of the sprinkler water stream. Once in the water path, the breakup screw disrupts a portion of the water stream so as to ensure that the stream reaches areas close to the sprinkler, and thereby ensuring the sprinkler stream doesn't “overshoot” certain areas of the turf nearest to the sprinkler.

The breakup port 114 permits the disrupted water stream to exit the sprinkler through the nozzle 108 without being straightened or significantly modified. Thus, the breakup port 114 allows the disrupted portion of the water stream to hit areas of the turf located near the sprinkler 100.

Looking now to the upper patterned section 120, three main tube shapes can be seen: hexagonal ports 112, pentagonal ports 118, and four sided irregularly shaped ports 113. The pentagonal ports 118 line the top and bottom of this honeycomb section, the hexagonal ports 112 are located in the center region; and the irregularly shaped ports 113 are located on both ends of the bottom line of hexagonal ports 112.

The overall pattern maximizes flow area within a defined space while still maintaining tube like structures within that area to straighten the flow. As can be seen in FIGS. 2, 3, and 5, the pentagonal ports 118 and irregularly shaped ports 113 carve out the area in the nozzle 108 where a hexagonal shape will not fit (e.g. typically around the outer edges of a circular nozzle). By using shapes other then the hexagonal ports 112, water flow through this remaining area in said nozzle 108 is maximized.

The tube shape which maximizes the tube diameter and minimizes material between the tubes is the hexagon since every wall of the hexagon is shared in common with an adjacent tube. In other words, the hexagonal port 112 makes efficient use of space within nozzle 108, since it results in less material being present between the tubes that will block water flow. For this reason the predominant shape of the tubes is hexagonal. And as a result, this pattern translates into a maximizing water flow through the nozzle 108, maximizing water throw velocity, maximizing water flow distance, and at the same time significantly reducing water turbulence.

In the preferred embodiment of the present invention there is a single row of hexagonal ports 112 along with pentagonal ports 112 and irregularly shaped ports 118 in those spaces where hexagonal shapes do not maximize the flow area. However, additional hexagonal rows could be added to the nozzle 108, as desired. Adding rows would require a reduction in port size that would affect the flow characteristics of the nozzle. In this regard, the port diameter, port height and wall thickness of the ports 112, 113, and 118 may also be varied to provide different nozzle 108 performance characteristics.

For example, an increase in a port diameter will increase water flow and water velocity. However, the water straightening capability of the now reduced diameter ports conversely decreases.

Similarly, the port height, (i.e. the length of the port tube), may also be increased to enhance the water straightening performance of the nozzle 108. However, such lengthening of the port height will negatively impact water flow velocity. In a preferred embodiment, the port height is 0.250 inches.

Finally, the wall thickness of each of these ports may be decreased to improve water flow and water velocity. However, such thinning of the walls will likely, decrease lifespan and durability of the nozzle 108.

As a result, it can be seen that, the nozzle 108 may be optimized for various sprinkler designs and uses. In this regard, further factors to consider in conjunction with the previously mentioned aspects may include the nozzle material, water pressure, and overall diameter of the nozzle.

In a preferred embodiment, it has been determined by the inventor that an optimized nozzle 108 in accordance with the present invention uses a total of 12 ports, wherein the mean diameter of each port is 0.095 inches; and wherein the wall thickness between ports is 0.013. Preferably, the nozzle 108 produces a Reynolds number of less than 2300.

Finally, it should be noted that the nozzle 108 may vary in overall shape according to the present invention. For example, the nozzle 108 may be a triangle, square, pentagon, hexagon, or other desired shape (not shown). Nonetheless, the same principles for optimizing flow reducing turbulence as described above applies to these alternative designs.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A sprinkler nozzle comprising:
a nozzle framework sized for positioning in an exit opening of a sprinkler;
a pattern of ports traversing at least a portion of said nozzle framework;
each of said ports having a shape complimentary to an adjacent port so as to minimize the amount of material present between each of said ports; and
said pattern of ports having a thickness along a longitudinal axis of said support frame so as to reduce turbulence in water traveling through said exit opening of said sprinkler.

2. A sprinkler nozzle as set forth in claim 1, wherein the majority of said ports have a hexagonal shape.

3. A sprinkler nozzle as set forth in claim 1, wherein said pattern of ports includes ports of a hexagonal shape and ports of a pentagonal shape.

4. A sprinkler nozzle as set forth in claim 3, wherein said pattern of ports further includes at least one port of an irregular shape.

5. A sprinkler nozzle as set forth in claim 1, further comprising a break up port located adjacent said pattern of ports.

6. A sprinkler nozzle as set forth in claim 1, wherein said pattern of ports includes at least one row of hexagonally shaped ports.

7. A sprinkler nozzle as set forth in claim 1, further comprising a connecting mechanism disposed on said nozzle framework.

8. A sprinkler comprising:
a sprinkler body having a water inlet port and a water outlet port;
a nozzle disposed in said water outlet port;
a water straightening mechanism disposed on said nozzle; and
said water straightening mechanism being the primary source of water straightening structure on said sprinkler.

9. A sprinkler as set forth in claim 8, wherein said water straightening mechanism is a pattern of water straightening ports.

10. A sprinkler as set forth in claim 9, wherein each of said water straightening ports is shaped so as to minimize the amount of material present between adjacent ports.

11. A sprinkler as set forth in claim 9, wherein a majority of said water straightening ports are hexagonal in shape.

12. A sprinkler as set forth in claim 10, wherein said water straightening ports comprise hexagonal ports and hectagonal ports.

13. A sprinkler as set forth in claim 12, wherein said water straightening ports further comprise irregularly shaped ports.

14. A sprinkler as set forth in claim 9, wherein said pattern includes at least one row of hexagonally shaped ports.

15. A method watering turf comprising:
providing a sprinkler having an inlet port and an exit port;
introducing a flow of water into said inlet port and out of said exit port; and
reducing turbulence of said water primarily at the exit port of said sprinkler.

16. A method according to claim 15, wherein the reducing of turbulence includes introducing said flow of water into a straightening mechanism at said exit port.

17. A method according to claim 15, wherein the reducing of turbulence includes forcing said flow of water through a patterned nozzle located at said exit port.

18. A method according to claim 17, wherein forcing said flow of water through a patterned nozzle includes forcing said flow of water through a pattern of hexagonally shaped flow ports.

19. A method according to claim 18, wherein forcing said flow of water includes forcing said flow of water through a pattern that further includes pentagonally shaped flow ports.

20. A method according to claim 19, wherein forcing said flow of water includes forcing said flow of water through a pattern that further includes irregularly shaped flow ports.
